(19) United States
(12) Patent Application Publication
(10) Pub. No.: US 2021/0166839 A1
(43) Pub. Date: Jun. 3, 2021

(54) TRANSMISSION LINE USING NANOSTRUCTURED MATERIAL AND METHOD OF MANUFACTURING THE TRANSMISSION LINE

(71) Applicant: SENSORVIEW INCORPORATED, Gyeonggi-do (KR)

(72) Inventors: Byoung Nam KIM, Gyeonggi-do (KR); Kyoung Il KANG, Gyeonggi-do (KR)

(21) Appl. No.: 17/265,896

(22) PCT Filed: Aug. 30, 2019
(86) PCT No.: PCT/KR2019/011107

§ 371 Date: Feb. 4, 2021

(30) Foreign Application Priority Data
Aug. 31, 2018 (KR) 10-2018-0103892

(51) Int. Cl. H01B 13/00; H01B 7/02; H01B 3/30; H01B 7/08; H01B 13/06

(52) U.S. Cl. CPC H01B 13/0016; H01B 7/0225; H01B 3/306; H01B 13/0026; H01B 13/065; H01B 13/0033; H01B 7/0807

(57) ABSTRACT

Disclosed is a method of manufacturing a transmission line using a nanostructured material and a method of manufacturing the transmission line. The transmission line using a nanostructured material includes a first nanoflon layer formed of nanoflon, a first insulating layer located above the first nanoflon layer, a first pattern formed by etching a first conductive layer formed on the first insulating layer, and a first ground layer located below the first nanoflon layer. Here, the nanoflon is a nanostructured material formed by electrospinning a liquid resin at a high voltage.

### CROSS-REFERENCE TO RELATED APPLICATION

This application claims priority to and the benefit of Korean Patent Application No. 2018-0103892, filed on Aug. 31, 2018, the disclosure of which is incorporated herein by reference in its entirety.

### FIELD

The present invention relates to a transmission line, and more particularly, to a transmission line using a nanostructured material formed by electrospinning a liquid resin at a high voltage and a method of manufacturing the transmission line.

### BACKGROUND

In order to transmit or treat a superhigh frequency signal at a small loss, a low-loss and high performance transmission line is necessary. Generally, losses at a transmission line are roughly divided into a conductor loss caused by a metal and a dielectric loss caused by a dielectric. Particularly, a loss caused by a dielectric increases when permittivity of a dielectric is higher, and a power loss increases when resistance is greater.

Accordingly, in order to manufacture a low-loss and high performance transmission line for transmitting a superhigh frequency signal, it is necessary to use a material having low permittivity and a small loss tangent value. Particularly, in order to efficiently transmit signals having frequencies in bands of 3.5 GHz and 28 GHz used in 5G mobile communication network, the significance of a transmission line which has a low loss even in a superhigh frequency band increases more and more.

### SUMMARY

The present invention is directed to providing a transmission line using a nanostructured material, which has low permittivity and is capable of reducing a loss tangent value at the low permittivity to reduce a loss at the transmission line caused by a dielectric.

The present invention is also directed to providing a method of manufacturing a transmission line using a nanostructured material formed through electrospinning, which has low permittivity and is capable of reducing a loss tangent value at the low permittivity to reduce a loss at a transmission line caused by a dielectric.

According to an aspect of the present invention, there is provided a transmission line using a nanostructured material. The transmission line includes a first nanoflon layer formed of nanoflon, a first insulating layer located above the first nanoflon layer, a first pattern formed by etching a first conductive layer formed on the first insulating layer, and a first ground layer located below the first nanoflon layer. Here, the nanoflon is a nanostructured material formed by electrospinning a liquid resin at a high voltage.

The first pattern may include ground lines and a signal line which are formed by etching the first conductive layer. The transmission line may further include a second nanoflon layer located on the first pattern formed on the first insulating layer and the first insulating layer exposed by the etching and a second ground layer located on the second nanoflon layer.

The transmission line may further include a second nanoflon layer located on the first pattern formed on the first insulating layer and the first insulating layer exposed by the etching, a second ground layer located on the second nanoflon layer, a third nanoflon layer located on the second ground layer, a second insulating layer located on the third nanoflon layer, and a second pattern formed by etching a second conductive layer formed on the second insulating layer and transmits a signal.

The second pattern may include ground line and a signal line configured to transmit a signal, which are formed by etching the second conductive layer.

The transmission line may further include a fourth nanoflon layer located on the second pattern formed on the second insulating layer and the second insulating layer exposed by the etching and a third ground layer located on the fourth nanoflon layer. The first and second insulating layers may be formed of polyimide (PI), and the conductive layers may be formed of copper (Cu).

According to another aspect of the present invention, there is provided a method of manufacturing a transmission line using a nanostructured material. The method includes forming a first conductive layer on a first insulating layer, forming a first pattern, which transmits and receives a signal, by etching the first conductive layer, locating the first insulating layer above a first nanoflon layer formed of nanoflon, and locating a first ground layer below the first nanoflon layer. Here, the nanoflon is a nanostructured material formed by electrospinning a liquid resin at a high voltage. The forming of the first pattern may include forming ground lines and a transmission-signal line by etching the first conductive layer.

The method may further include locating a second nanoflon layer on the first pattern formed on the first insulating layer and the first insulating layer exposed by the etching and locating a second ground layer on the second nanoflon layer.

The method may further include locating a second nanoflon layer on the first pattern formed on the first insulating layer and the first insulating layer exposed by the etching, locating a second ground layer on the second nanoflon layer, locating a third nanoflon layer on the second ground layer, locating a second insulating layer on the third nanoflon layer, forming a second conductive layer on the second insulating layer, and forming a second pattern, which transmits and receives a signal, by etching the second conductive layer.

The method may further include locating a second nanoflon layer on the first pattern formed on the first insulating layer and the first insulating layer exposed by the etching, locating a second ground layer on the second nanoflon layer, locating a third nanoflon layer on the second ground layer, forming a second conductive layer on a second insulating layer, forming a second pattern, which transmits and receives a signal, by etching the second conductive layer, and locating the second insulating layer on the third nanoflon layer.

The forming of the second pattern may include forming a transmission-signal line and ground line by etching the second conductive layer.

The method may further include locating a fourth nanoflon layer on the second pattern formed on the second insulating layer and the second insulating layer exposed by the etching and bonding a third ground layer to the fourth nanoflon layer.

The locating may be performed through adhesion using an adhesive tape or an adhesive or using thermal adhesion in which heat is applied to an adhesive tape.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates an example of an apparatus which manufactures nanoflon through electrospinning;

FIG. 2 illustrates an example of a stripline transmission line;

FIG. 3 is a cross-sectional view illustrating a first embodiment of a transmission line using a nanostructured material according to the present invention;

FIG. 4 is a cross-sectional view of the transmission line, which illustrates adhesion to a first nanoflon layer according to the present invention;

FIG. 5 is a cross-sectional view illustrating a second embodiment of the transmission line using the nanostructured material according to the present invention;

FIG. 6 is a cross-sectional view illustrating a third embodiment of the transmission line using the nanostructured material according to the present invention;

FIG. 7 is a cross-sectional view of the transmission line, which illustrates adhesion to a second nanoflon layer 610 according to the present invention;

FIG. 8 is a cross-sectional view illustrating a fourth embodiment of the transmission line using the nanostructured material according to the present invention;

FIG. 9 is a cross-sectional view illustrating a fifth embodiment of the transmission line using the nanostructured material according to the present invention;

FIG. 10 is a cross-sectional view illustrating a sixth embodiment of the transmission line using the nanostructured material according to the present invention;

FIGS. 11A, 11B and 11C illustrate a first embodiment of a method of manufacturing a transmission line using a nanostructured material according to the present invention;

FIG. 12 illustrates a second embodiment of the method of manufacturing the transmission line using the nanostructured material according to the present invention;

FIGS. 13A and 13B illustrate a third embodiment of the method of manufacturing the transmission line using the nanostructured material according to the present invention;

FIGS. 14A and 14B illustrate a fourth embodiment of the method of manufacturing the transmission line using the nanostructured material according to the present invention;

FIGS. 15A, 15B, and 15C illustrate a fifth embodiment of the method of manufacturing the transmission line using the nanostructured material according to the present invention;

FIGS. 16A, 16B, 16C, 16D, and 16E illustrate a sixth embodiment of the method of manufacturing the transmission line using the nanostructured material according to the present invention;

FIGS. 17A and 17B illustrate a seventh embodiment of the method of manufacturing the transmission line using the nanostructured material according to the present invention;

FIGS. 18A, 18B, 18C, and 18D illustrate an eighth embodiment of the method of manufacturing the transmission line using the nanostructured material according to the present invention; and

FIGS. 19A and 19B illustrate a ninth embodiment of the method of manufacturing the transmission line using the nanostructured material according to the present invention.

### DETAILED DESCRIPTION

Hereinafter, exemplary embodiments of the present invention will be described in detail with reference to the attached drawings. Since embodiments disclosed in the specification and components shown in the drawings are merely exemplary embodiments of the present invention and do not represent an entirety of the technical concept of the present invention, it should be understood that a variety of equivalents and modifications capable of substituting the embodiments and the components may be present at the time of filing of the present application.

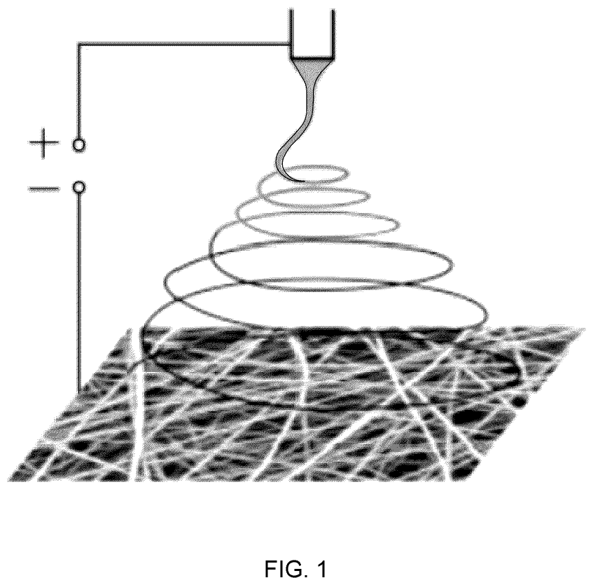

First, a nanostructured material used in a transmission line using a nanostructured material according to the present invention will be described. The nanostructured material refers to a material formed by electrospinning a liquid resin at a high voltage and will be referred to as nanoflon herein. FIG. 1 illustrates an example of an apparatus which manufactures nanoflon through electrospinning. When a polymer solution including polymers is injected into an injector and a high voltage is applied between the injector and a substrate on which spinning is performed and the polymer solution flows at a certain speed thereinto, as electricity is applied to a liquid suspended from an end of a capillary due to surface tension, a nano-sized thread is formed, and as time passes, non-woven nanofibers which are a nanostructured material are accumulated. A material formed by accumulating nanofibers as described above is nanoflon. As the polymer material used for electrospinning, for example, there are present polyurethane (PU), polyvinylidine diflouride (PVDF), nylon (polyamide), polyacrylonitrile (PAN), and the like. Nanoflon may be used as a dielectric of a transmission line due to low permittivity and a large amount of air therein.

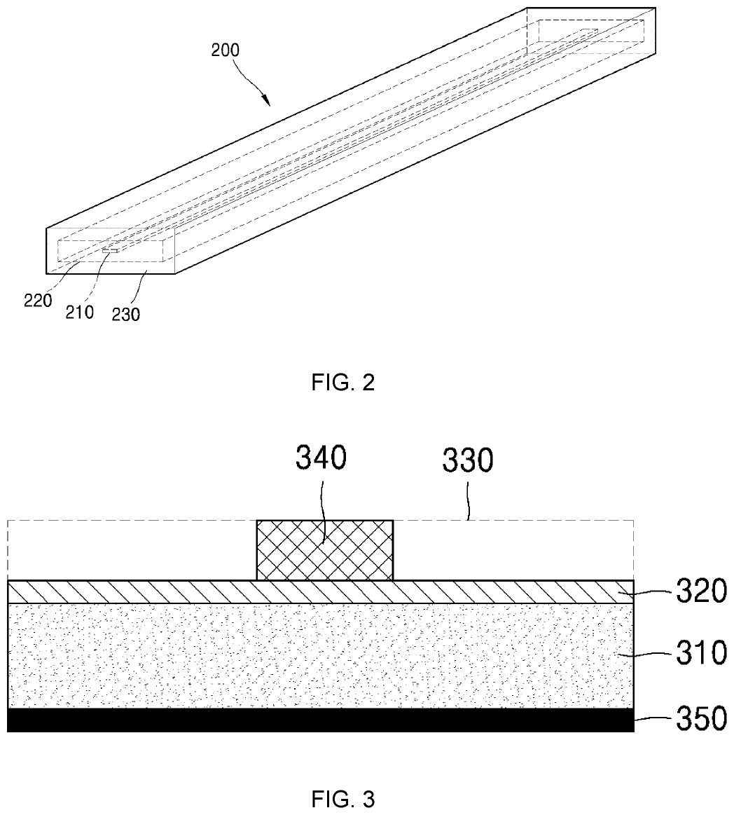

FIG. 2 illustrates an example of a stripline transmission line. Referring to FIG. 2, the stripline transmission line may include a signal line 210 which transmits a signal, a dielectric 220 which surrounds the signal line 210, and a conductor 230 which functions as an outer shield.

FIG. 3 is a cross-sectional view illustrating a first embodiment of a transmission line using a nanostructured material according to the present invention. Referring to FIG. 3, the first embodiment with respect to the transmission line using the nanostructured material according to the present invention includes a first nanoflon layer 310, a first insulating layer 320, a first pattern 340, and a first ground layer 350. The first nanoflon layer 310 includes nanoflon. The first insulating layer 320 includes an insulating material and is located above the first nanoflon layer 310, and for example, may be located through adhesion. The insulating material is a material capable of preventing an etching solution from being absorbed, and for example, polyimide (PI), as thermally durable plastic, which is an organic polymer compound may be used.

The first pattern 340 may be formed by etching a first conductive layer 330 formed on the first insulating layer 320 and functions as a transmission line through which a signal is transmitted. Also, the first ground layer 350 may be located below the first nanoflon layer 310, and for example, may be located by adhesion.

The adhesion to the first nanoflon layer 310 may be performed using an adhesive tape, an adhesive, or thermal adhesion in which heat is applied to an adhesive tape. Also, the first insulating layer 320 may be a first coating layer formed by coating the first nanoflon layer 310 with an insulating material.

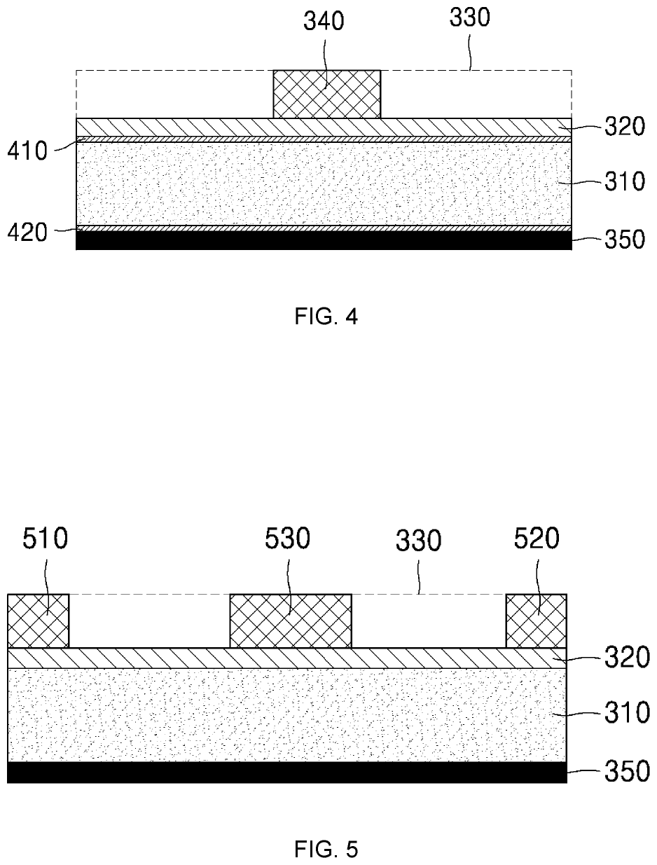

FIG. 4 is a cross-sectional view of the transmission line which illustrates adhesion to the first nanoflon layer 310 according to the present invention. Reference numeral 410 indicates adhesion between the first nanoflon layer 310 and the first insulating layer 320, and reference numeral 420 indicates adhesion between the first nanoflon layer 310 and the first ground layer 350.

FIG. 5 is a cross-sectional view illustrating a second embodiment of the transmission line using the nanostructured material according to the present invention. Referring to FIG. 5, in the second embodiment with respect to the transmission line using the nanostructured material according to the present invention, when the first embodiment of the transmission line using the nanostructured material according to the present invention is formed, ground lines 510 and 520 are further formed and the first pattern 530 is used as a signal line. That is, the ground lines 510 and 520 and a signal line 530 are formed by etching the first conductor layer 330.

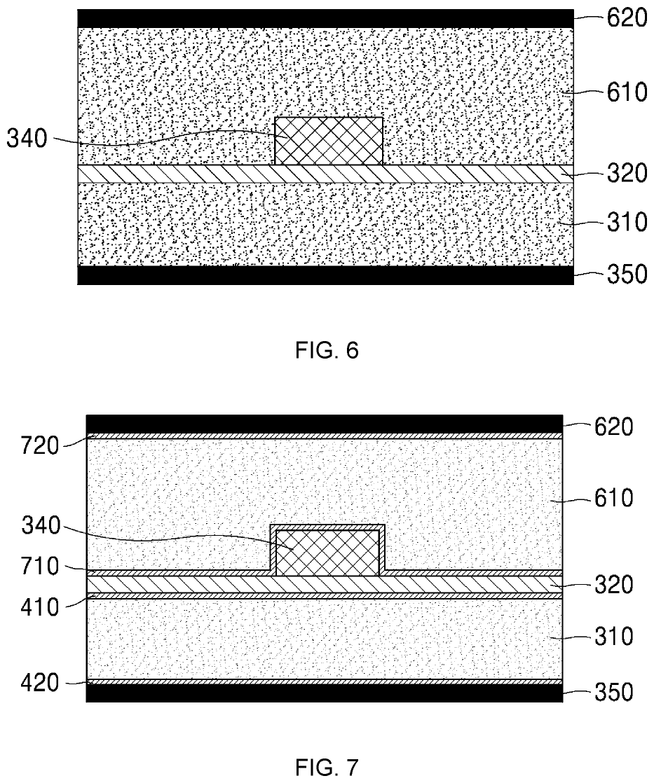

FIG. 6 is a cross-sectional view illustrating a third embodiment of the transmission line using the nanostructured material according to the present invention. Referring to FIG. 6, the third embodiment with respect to the transmission line using the nanostructured material according to the present invention further includes a second nanoflon layer 610 and a second ground layer 620 in addition to the first embodiment (refer to FIG. 3) of the transmission line using the nanostructured material according to the present invention.

The second nanoflon layer 610 may be located above the first pattern 340 formed on the first insulating layer 320 and the first insulating layer 320 exposed by the etching, and may be located through adhesion. The second ground layer 620 may be located above the second nanoflon layer 610 and may be located through adhesion. The adhesion to the second nanoflon layer 610 may be performed using an adhesive tape, an adhesive, or thermal adhesion in which heat is applied to an adhesive tape.

FIG. 7 is a cross-sectional view of the transmission line which illustrates adhesion to the second nanoflon layer 610 according to the present invention. Reference numeral 710 indicates adhesion between the second nanoflon layer 610 and the first insulating layer 320 and the first pattern 340, and reference numeral 720 indicates adhesion between the second nanoflon layer 610 and the second ground layer 620.

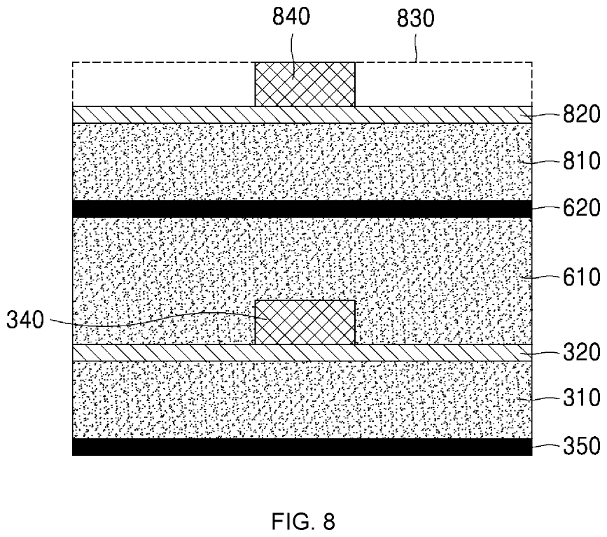

FIG. 8 is a cross-sectional view illustrating a fourth embodiment of the transmission line using the nanostructured material according to the present invention. Referring to FIG. 8, the fourth embodiment with respect to the transmission line using the nanostructured material according to the present invention further includes a third nanoflon layer 810, a second insulating layer 820, and a second pattern 840 in addition to the third embodiment (refer to FIG. 6) of the transmission line using the nanostructured material according to the present invention. The third nanoflon layer 810 may be located above the second ground layer 620 and may be located through adhesion. The second insulating layer 820 may be located on the third nanoflon layer 810 and may be located through adhesion. The second pattern 840 may be formed by etching a second conductive layer 830 formed on the second insulating layer 820 and is used as a signal line which transmits a signal. The adhesion to the third nanoflon layer 810 may be performed using an adhesive tape, an adhesive, or thermal adhesion in which heat is applied to an adhesive tape. Also, the second insulating layer 820 may be a second coating layer formed by coating the third nanoflon layer 810 with an insulating material.

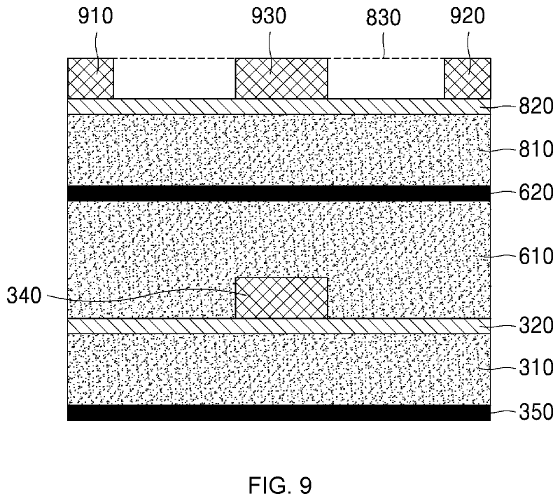

FIG. 9 is a cross-sectional view illustrating a fifth embodiment of the transmission line using the nanostructured material according to the present invention. Referring to FIG. 9, in the fifth embodiment with respect to the transmission line using the nanostructured material according to the present invention, when the fourth embodiment of the transmission line using the nanostructured material according to the present invention is formed, ground lines 910 and 920 are further formed and the second pattern 930 is used as a signal line. That is, the ground lines 910 and 920 and the signal line 930 are formed by etching the second conductor layer 830.

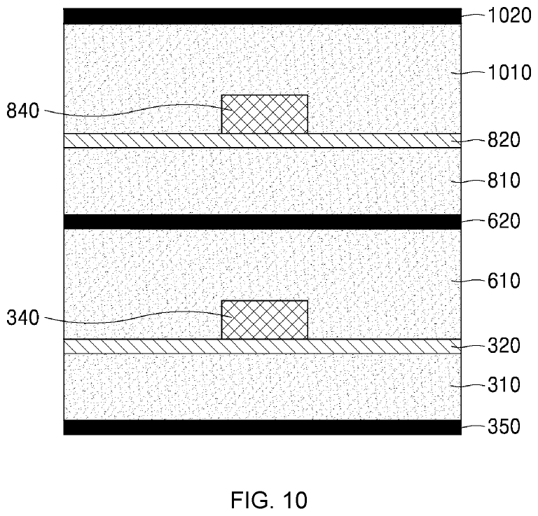

FIG. 10 is a cross-sectional view illustrating a sixth embodiment of the transmission line using the nanostructured material according to the present invention. Referring to FIG. 10, the sixth embodiment with respect to the transmission line using the nanostructured material according to the present invention further includes a fourth nanoflon layer 1010 and a third ground layer 1020 in addition to the fourth embodiment (refer to FIG. 8) of the transmission line using the nanostructured material according to the present invention.

The fourth nanoflon layer 1010 may be located on the second pattern 840 formed on the second insulating layer 820 and the second insulating layer 820 exposed by the etching, and may be located through adhesion. The third ground layer 1020 may be located on the fourth nanoflon layer 1010 and may be located through adhesion. The adhesion to the fourth nanoflon layer 1010 may be performed using an adhesive tape, an adhesive, or thermal adhesion in which heat is applied to an adhesive tape.

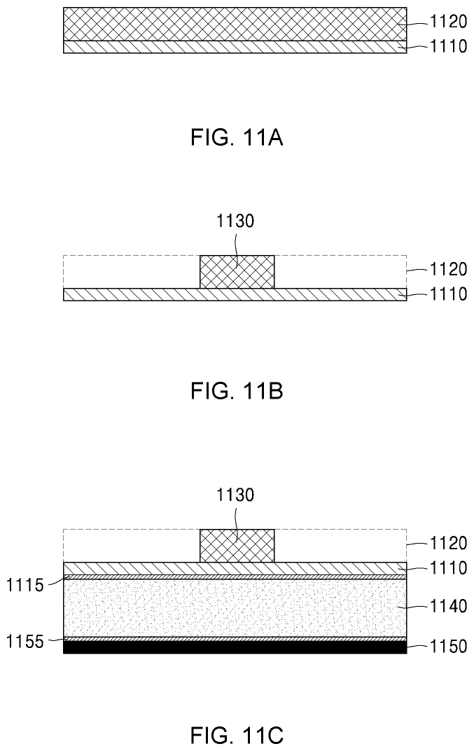

FIG. 11 illustrates a first embodiment of a method of manufacturing a transmission line using a nanostructured material according to the present invention. Referring to FIG. 11(a), a first conductive layer 1120 is formed on a first insulating layer 1110. Referring to FIG. 11(b), a first pattern 1130, which transmits and receives a signal, is formed by etching the first conductor layer 1120. In the etching, the first conductive layer 1120 may be etched using a product in which the first conductive layer 1120 is formed on the first insulating layer 1110.

Referring to FIG. 11(c), the first insulating layer 1110 is located above a first nanoflon layer 1140 formed of nanoflon. For example, the first insulating layer 1110 may be located above the first nanoflon layer 1140 by allowing the first insulating layer 1110 to adhere (1115) to the first nanoflon layer 1140, and the adhesion may be performed using an adhesive tape, an adhesive, or thermal adhesion in which heat is applied to an adhesive material. A first ground layer 1150 is located below the first nanoflon layer 1140. For example, the first ground layer 1150 may adhere (1155) to a bottom of the first nanoflon layer 1140, and the first ground layer 1150 may be located on the bottom of the first nanoflon layer 1140 through the adhesion using an adhesive tape, an adhesive, or thermal adhesion in which heat is applied to an adhesive material.

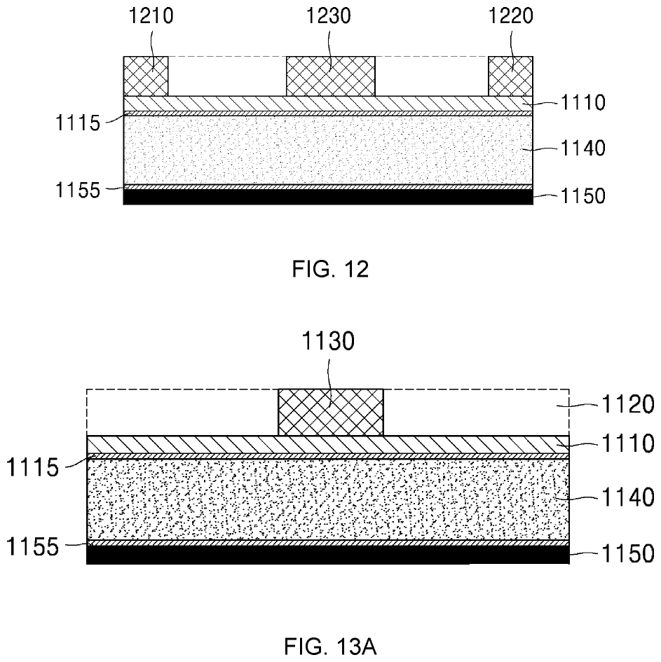

FIG. 12 illustrates a second embodiment of the method of manufacturing the transmission line using the nanostructured material according to the present invention. Referring to FIG. 12, in the second embodiment with respect to the method of manufacturing the transmission line using the nanostructured material according to the present invention, when the first embodiment of the method of manufacturing the transmission line using the nanostructured material according to the present invention is formed as shown in FIG. 11(c), ground lines 1210 and 1220 are further formed and the first pattern 1230 is used as a signal line. That is, the ground lines 1210 and 1220 and a signal line 1230 may be formed by etching the first conductor layer 1120.

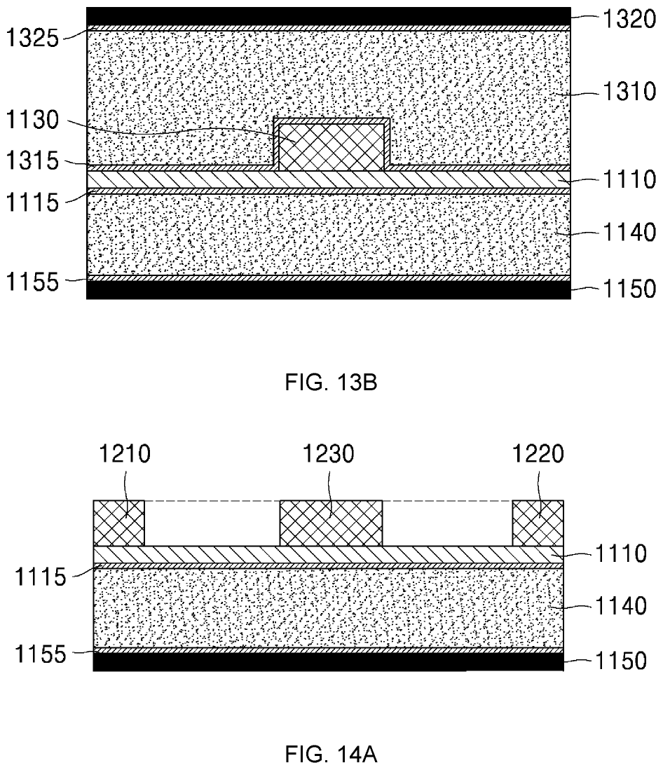

FIG. 13 illustrates a third embodiment of the method of manufacturing the transmission line using the nanostructured material according to the present invention. FIG. 13(a) illustrates the first embodiment, shown in FIG. 11(c), with respect to the method of manufacturing the transmission line using the nanostructured material according to the present invention. As shown in FIG. 13(b), a second nanoflon layer 1310 is located on a result of the first embodiment of the method of manufacturing the transmission line. For example, the second nanoflon layer 1310 may adhere (1315) to the first pattern 1130 formed on the first insulating layer 1120 and the first insulating layer 1110 exposed by etching in the first embodiment of the method of manufacturing the transmission line. Also, a second ground layer 1320 may be located on the second nanoflon layer 1310. The second ground layer 1320 may be located on the second nanoflon layer 1310 through adhesion 1325. The adhesion 1315 or 1325 may be performed using an adhesive or an adhesive or through thermal adhesion in which heat is applied to an adhesive tape.

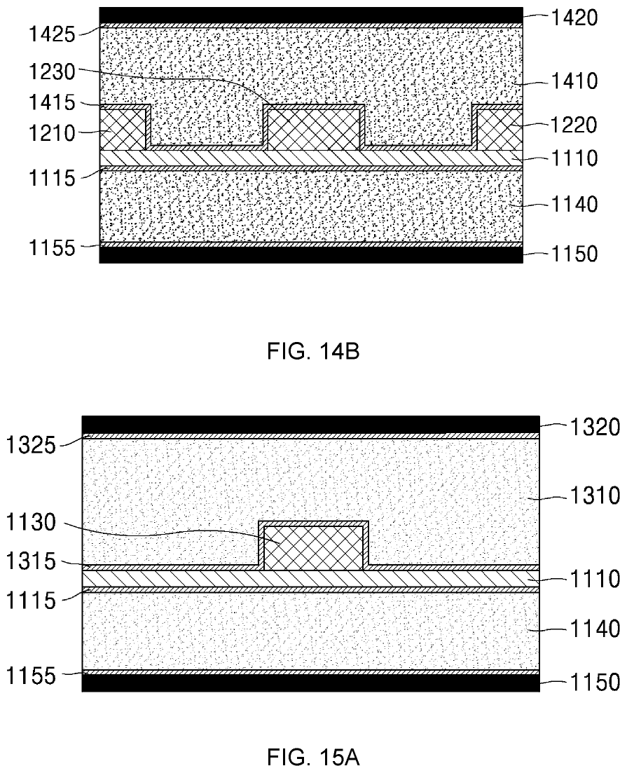

FIG. 14 illustrates a fourth embodiment of the method of manufacturing the transmission line using the nanostructured material according to the present invention. As shown in FIG. 14(b), a second nanoflon layer 1410 is located on a result of the second embodiment of the method of manufacturing the transmission line according to the present invention as shown in FIG. 14(a) and a second ground layer 1420 is located above the second nanoflon layer 1410. The second nanoflon layer 1410 may be located on the ground lines 1210 and 1220, the signal line 1230 and the first insulating layer 1110, and the second ground layer 1420 may be located on the second nanoflon layer 1410 through adhesions 1415 and 1425, respectively.

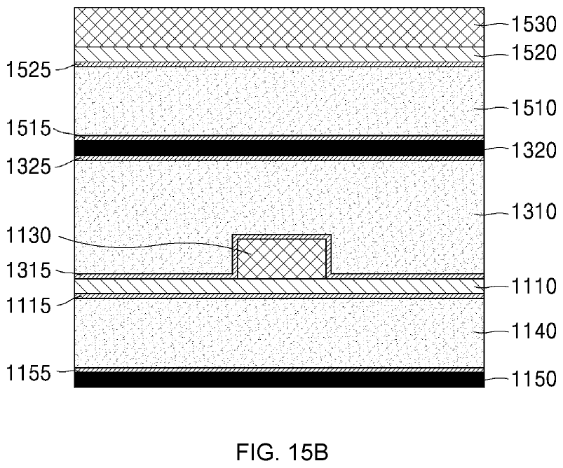

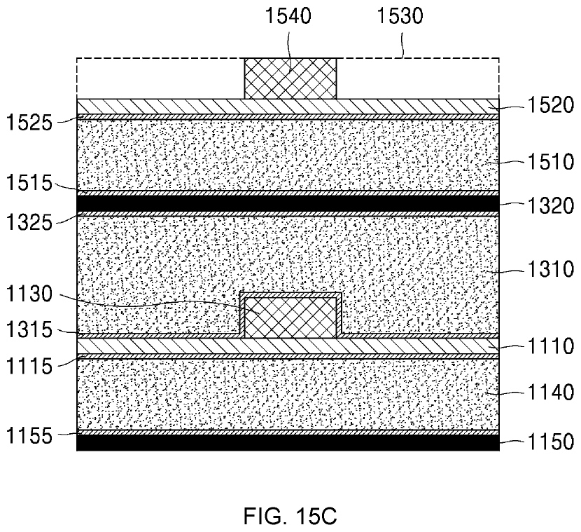

FIGS. 15a, 15b, and 15c illustrate a fifth embodiment of the method of manufacturing the transmission line using the nanostructured material according to the present invention. FIG. 15a illustrates the shown in FIG. 13(b) and a result of the third embodiment of the method of manufacturing the transmission line according to the present invention. Referring to FIG. 15b, a third nanoflon layer 1510 is located on the second ground layer 1320 of the result of the third embodiment of the method of manufacturing the transmission line according to the present invention as shown in FIG. 13(b), and then a second insulating layer 1520 is located on the third nanoflon layer 1510.

Referring to FIG. 15c, a second conductive layer 1530 is formed above the second insulating layer 1520, and then a second pattern 1540, which is a signal line, is formed by etching the second conductive layer 1530. The second ground layers 1320 and the second insulating layer 1520 which come into contact with the third nanoflon layer 1510 may adhere (1515 and 1525) thereto, respectively, using an adhesive tape or an adhesive or through thermal adhesion in which heat is applied to an adhesive material.

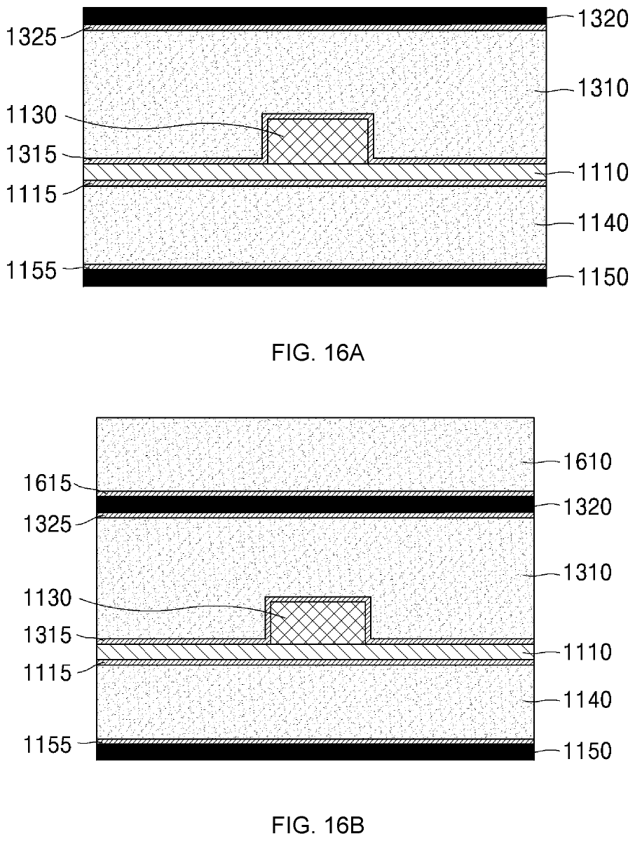

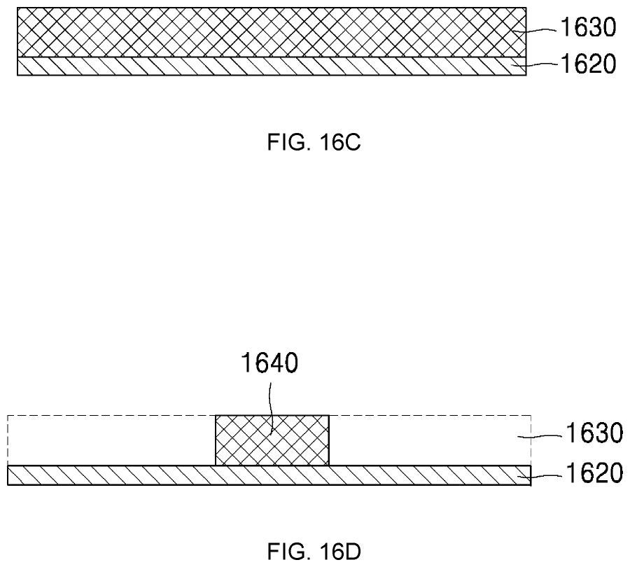

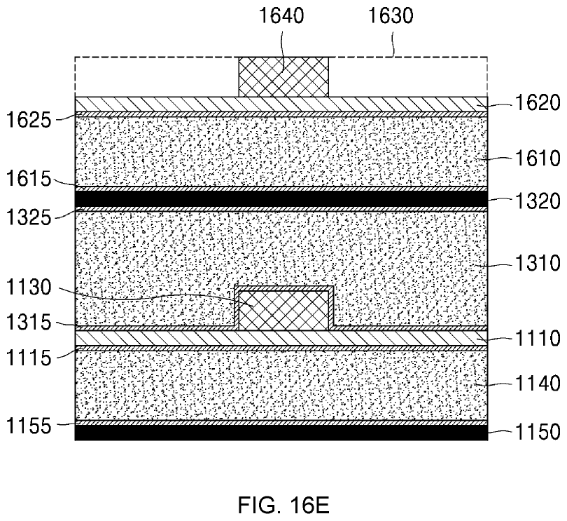

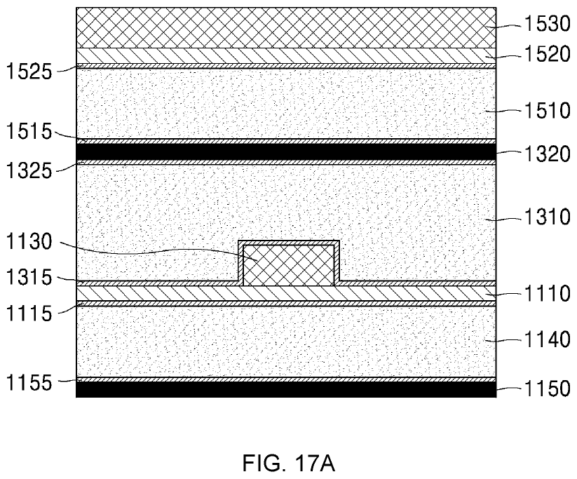

FIGS. 16a, 16b, 16c, 16d, and 16e illustrate a sixth embodiment of the method of manufacturing the transmission line using the nanostructured material according to the present invention. FIG. 16a illustrates the shown in FIG. 13(b) and the result of the third embodiment of the method of manufacturing the transmission line according to the present invention.

Referring to FIG. 16b, a third nanoflon layer 1610 is located on the second ground layer 1320 of the result of the third embodiment of the method of manufacturing the transmission line according to the present invention as shown in FIG. 16a.

Referring to FIG. 16c, a first conductive layer 1630 is formed on a first insulating layer 1620. Referring to FIG. 16d, a second pattern 1640, which transmits and receives a signal, is formed by etching the first conductor layer 1630. In the etching, the first conductive layer 1630 may be etched using a product in which the first conductive layer 1630 is formed on the first insulating layer 1620.

Referring to FIG. 16e, the second insulating layer 1620, on which the second pattern 1640 is formed as shown in FIG. 16d, is located above the third nanoflon layer 1610 located on the second ground layer 1320 as shown in FIG. 16b. The second ground layer 1320 and the second insulating layer 1620 which come into contact with the third nanoflon layer 1610 may adhere (1615 and 1625) thereto, respectively, using an adhesive tape or an adhesive or through thermal adhesion in which heat is applied to an adhesive material.

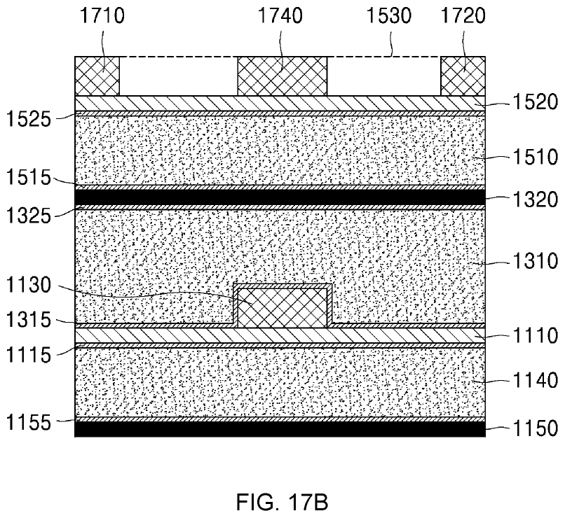

FIGS. 17a and 17b illustrate a seventh embodiment of the method of manufacturing the transmission line using the nanostructured material according to the present invention. FIG. 17a illustrates the shown in FIG. 15b and illustrates forming of the second conductive layer 1530 on the second insulating layer 1520 in the fifth embodiment of the method of manufacturing the transmission line according to the present invention. Referring to FIG. 17b, the fifth embodiment of the method of manufacturing the transmission line according to the present invention is formed as shown in FIG. 15b, and then a signal line 1730 and ground lines 1710 and 1720 are formed by etching the second conductive layer 1530.

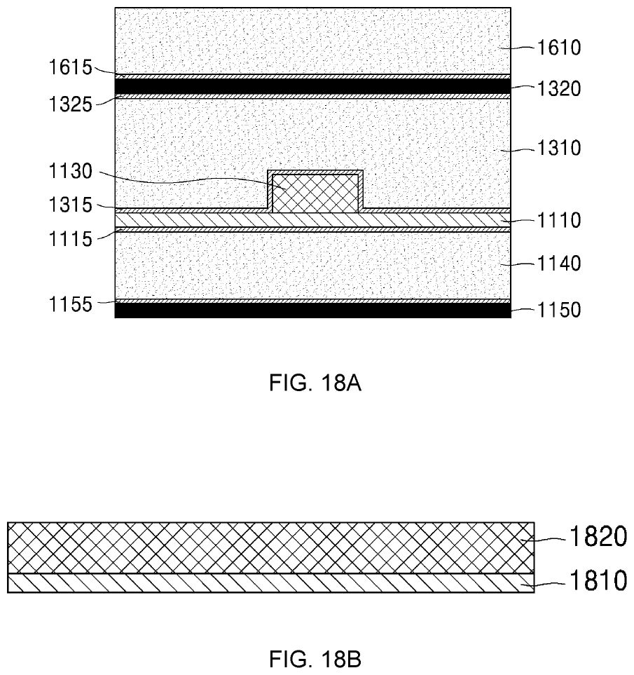

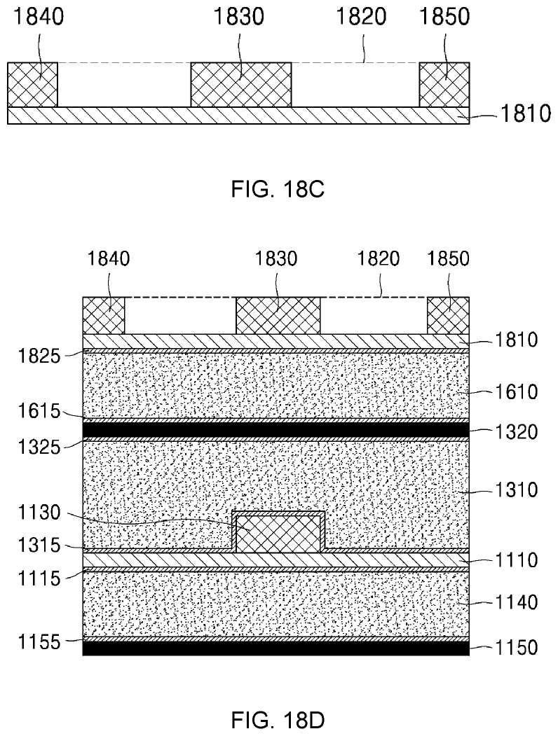

FIGS. 18a, 18b, 18c, and 18d illustrate an eighth embodiment of the method of manufacturing the transmission line using the nanostructured material according to the present invention. FIG. 18a illustrates the shown in FIG. 16b and illustrates forming of the third nanoflon layer 1610 on the second ground layer 1320 in the third embodiment of the method of manufacturing the transmission line according to the present invention. Referring to FIG. 18b, a first conductive layer 1820 is formed on a first insulating layer 1810. Referring to FIG. 18c, a second pattern 1830, which transmits and receives a signal, and two ground lines 1840 and 1850 are formed by etching the first conductor layer 1820. In the etching, the first conductive layer 1820 may be etched using a product in which the first conductive layer 1820 is formed on the first insulating layer 1810.

Referring to FIG. 18d, the first insulating layer 1810, on which the second pattern 1830 and the ground lines 1840 and 1850 are formed as shown in FIG. 18c, is located above the third nanoflon layer 1610 located on the second ground layer 1320 as shown in FIG. 18a. The second ground layer 1320 and the first insulating layer 1810 which come into contact with the third nanoflon layer 1610 may adhere (1615 and 1825) thereto, respectively, using an adhesive tape or an adhesive or through thermal adhesion in which heat is applied to an adhesive material.

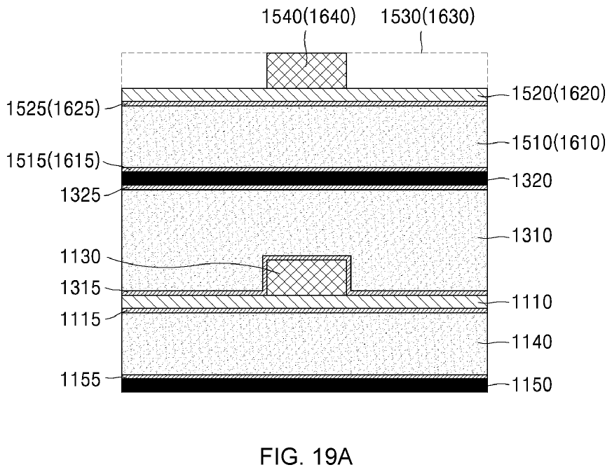

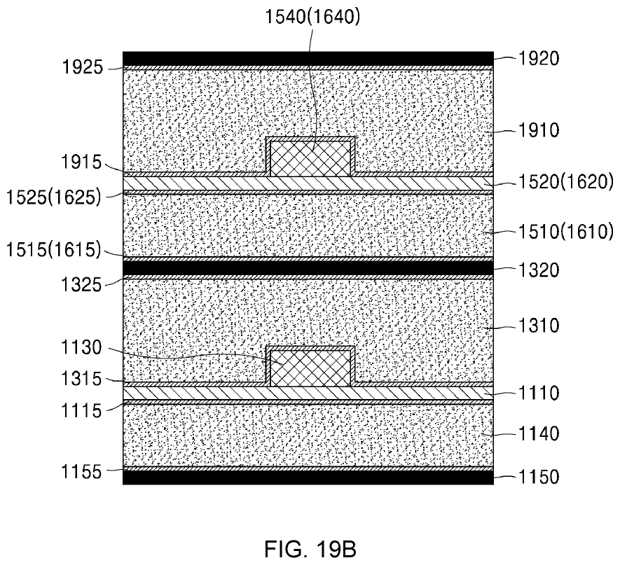

FIGS. 19a and 19b illustrate a ninth embodiment of the method of manufacturing the transmission line using the nanostructured material according to the present invention. FIG. 19a illustrates the shown in FIGS. 15c and 16e and illustrates results of the fifth and sixth embodiments of the method of manufacturing the transmission line using the nanostructured material according to the present invention.

Referring to FIG. 19b, a fourth nanoflon layer 1910 is located on the second pattern 1540 formed in the fifth embodiment of the method of manufacturing the transmission line or the second pattern 1640 formed in the sixth embodiment of the method of manufacturing the transmission line and the second insulating layer 1520 or 1620 exposed by etching, and then a third ground layer 1920 is formed on the fourth nanoflon layer 1910. Here, the fourth nanoflon layer 1910 may be located on the second pattern 1540 or 1640 and the second insulating layer 1520 or 1620 exposed by etching through adhesions 1915 and 1925 using an adhesive tape, an adhesive, or thermal adhesion in which heat is applied to an adhesive material.

According to the embodiments of the present invention, in a transmission line using a nanostructured material and a method of manufacturing the transmission line, a nanostructured material formed by electrospinning a resin at a high voltage is used as a dielectric of a transmission line such that the permittivity of the dielectric of the transmission line may be low and a loss tangent value may be reduced at the low permittivity.

Particularly, the transmission line using the nanostructured material may be used as a low-loss flat cable for reducing a transmission loss of a highfrequency signal in a band from 3.5 GHz and 28 GHz used in a five generation (5G) mobile communication network.

Although the embodiments of the present invention have been described with reference to the drawings, it should be understood that the embodiments are merely examples and a variety of modifications and equivalents thereof may be made by one of ordinary skill in the art. Therefore, the technical scope of the present invention should be defined by the technical concept of the attached claims.

1. A transmission line using a nanostructured material, comprising:
a first nanoflon layer formed of nanoflon;
a first insulating layer located above the first nanoflon layer;
a first pattern formed by etching a first conductive layer formed on the first insulating layer; and
a first ground layer located below the first nanoflon layer,
wherein the nanoflon is a nanostructured material formed by electrospinning a liquid resin at a high voltage.

2. The transmission line of claim 1, wherein the first pattern comprises ground lines and a signal line, which are formed by etching the first conductive layer.

3. The transmission line of claim 1, further comprising:
a second nanoflon layer located on the first pattern formed on the first insulating layer and the first insulating layer exposed by the etching; and
a second ground layer located on the second nanoflon layer.

4. The transmission line of claim 1, further comprising:
a second nanoflon layer located on the first pattern formed on the first insulating layer and the first insulating layer exposed by the etching;
a second ground layer located on the second nanoflon layer;
a third nanoflon layer located on the second ground layer;
a second insulating layer located on the third nanoflon layer; and
a second pattern formed by etching a second conductive layer formed on the second insulating layer and transmits a signal.

5. The transmission line of claim 4, wherein the second pattern comprises ground line and a signal line configured to transmit a signal, which are formed by etching the second conductive layer.

6. The transmission line of claim 4, wherein the second insulating layer is a second coating layer formed by coating a top of the third nanoflon layer with an insulating material.

7. The transmission line of claim 4, further comprising:
a fourth nanoflon layer located on the second pattern formed on the second insulating layer and the second insulating layer exposed by the etching; and
a third ground layer located on the fourth nanoflon layer.

8. The transmission line of claim 1, wherein the first pattern comprises ground lines and a signal line, which are formed by etching the first conductive layer.

9. The transmission line of claim 1, wherein the first insulating layer is a first coating layer formed by coating a top of the first nanoflon layer with an insulating material.

10. The method according to claim 1, wherein the locating is performed through adhesion using an adhesive tape or an adhesive or using thermal adhesion in which heat is applied to an adhesive tape.

11. The transmission line according to claim 1, wherein the first to third insulating layers are polyimide (PI), and the conductive layers are copper (Cu).

12. A method of manufacturing a transmission line using a nanostructured material, the method comprising:
forming a first conductive layer on a first insulating layer;
forming a first pattern, which transmits and receives a signal, by etching the first conductive layer;
locating the first insulating layer above a first nanoflon layer formed of nanoflon; and
locating a first ground layer below the first nanoflon layer,
wherein the nanoflon is a nanostructured material formed by electrospinning a liquid resin at a high voltage.

13. The method of claim 12, wherein the forming of the first pattern comprises forming ground lines and a signal line by etching the first conductive layer.

14. The method of claim 12, further comprising:
locating a second nanoflon layer on the first pattern formed on the first insulating layer and the first insulating layer exposed by the etching; and
locating a second ground layer on the second nanoflon layer.

15. The method of claim 2, further comprising:
locating a second nanoflon layer on the first pattern formed on the first insulating layer and the first insulating layer exposed by the etching;
locating a second ground layer on the second nanoflon layer;
locating a third nanoflon layer on the second ground layer;
locating a second insulating layer on the third nanoflon layer;
forming a second conductive layer on the second insulating layer; and
forming a second pattern, which transmits and receives a signal, by etching the second conductive layer.

16. The method of claim 2, further comprising:
locating a second nanoflon layer on the first pattern formed on the first insulating layer and the first insulating layer exposed by the etching;
locating a second ground layer on the second nanoflon layer;
locating a third nanoflon layer on the second ground layer;
forming a second conductive layer on a second insulating layer;
forming a second pattern, which transmits and receives a signal, by etching the second conductive layer; and
locating the second insulating layer on the third nanoflon layer.

17. The method according to claim 15, wherein the forming of the second pattern comprises forming a signal line and ground line by etching the second conductive layer.

18. The method according to claim 15, further comprising:
locating a fourth nanoflon layer on the second pattern formed on the second insulating layer and the second insulating layer exposed by the etching; and
bonding a third ground layer to the fourth nanoflon layer.

19. The method according to claim 12, wherein the locating is performed through adhesion using an adhesive tape or an adhesive or using thermal adhesion in which heat is applied to an adhesive tape. Page 9 of 10
